(19) United States
(12) Patent Application Publication
(10) Pub. No.: US 2016/0363102 A1
(43) Pub. Date: Dec. 15, 2016

(54) Engine combustion system oxygen efficiency enhancing device with raised electrical voltage and improved installation method

(71) Applicant: Wanlop WIROJPAISIT, NAKORNRAJSIMA (TH)

(72) Inventor: Wanlop WIROJPAISIT, NAKORNRAJSIMA (TH)

(21) Appl. No.: 14/895,802

(22) PCT Filed: Dec. 29, 2014
(86) PCT No.: PCT/TH2014/000057

§ 371 Date: Dec. 3, 2015

(51) Int. Cl. F02M 35/10; B60R 16/03; G05F 3/08

(52) U.S. Cl. CPC F02M 35/10249; F02M 35/10327; G05F 3/08; B60R 16/03

(57) ABSTRACT

The engine combustion system oxygen efficiency enhancing device with raised electrical voltage and improved installation method is composed of a frequency generator (70) with one side connected to the car's electrical supply serving to generate high voltage half-wave frequency. The transformer (80) connected to the frequency generator (70) serves to receive voltage from the frequency generator (70) and convert voltage into high voltage-Level 1=1,000-8,000 Volts or Level 2=8,0001-15,000 Volts, or Level 3 15,001-20,000 Volts, or Level 4 20,001-30,000 Volts, or Level 5 30,001-60,000 Volts, and the electrical current is set at 0.0024-0.00004 Amperes through an electrical wire or metallic conductor (30) into the air duct (10).

### CROSS-REFERENCE TO RELATED APPLICATIONS

This application claims priority from International Application No. PCT/TH2014/000057 filed on Dec. 29, 2014.

### FIELD OF THE INVENTION

The present invention relates to the field of engine combustion systems and, in particular, to an engine combustion system oxygen efficiency enhancing device with raised electrical voltage and improved installation method.

### BACKGROUND OF THE INVENTION

Reference Thailand Patent No. 3632: The invention discloses the facts about the Oxygen Enhancing Device for Automobiles characterized by a closed enclosure containing electrical circuits and installed near the oxygen intake pipe. The device releases negative charges into the oxygen intake pipe in order to increase oxygen to supply the vehicle's combustion system. The invention is composed of the closed enclosure shaped like a box with electric wiring linked with the vehicle's power source so voltage can be received and released to the electric charge generating circuit composed of the electric current filtering and function display circuit, the astable multi-vibrator circuit, the peak-to-peak conversion circuit, and the high voltage conversion circuit installed in the closed enclosure. The current filtering and function display circuit receives direct current from the power source to be sent to the LED display function and further transmit electricity to the astable multi-vibrator circuit in order to release electricity to the transformer containing the peak-to-peak voltage conversion circuit serving to convert voltage from 6 volts to 630 volts in peak-to-peak manner and releasing high voltage to the high voltage circuit in order to raise the voltage to a high voltage level and the charge release cord for conducting and releasing high voltage negative charges into the air inside the oxygen intake pipe via the end of the charge release cord containing 3 conductive cords with the ends diagonally cut and installed at the filter or the oxygen intake pipe of the vehicle by inserting the diagonally-cut cord end into the oxygen intake pipe on three sides with the ends slightly exposed and the cord ends tilting toward the combustion chamber. The disadvantages are as follows:

### Disadvantage 1

In the previous invention, the conversion of voltage from 6 volts to 630 volts could not successfully generate high voltage conditions because the current adjustment was not disclosed. The voltage conversion from 6 volts to 630 volts caused no damage from electrocution or sparks.

Theoretically, the danger from electric shock does not lie in the voltage difference, but in the current. Thus, in converting voltage from 630 volts to 1,000-60,000 volts while preventing danger from electrocution or sparks, the electrical current must be lowered. In this invention, the voltage is converted to a high level of 1,000-60,000 volts, which is capable of releasing either negative or positive charges and related to the low current setting.

### Disadvantage 2

In the previous invention, the electrical charge was released by installing at the filter or the oxygen intake pipe of the vehicle by inserting the cord with diagonally cut ends into the oxygen intake pipe on three sides with the ends slightly exposed and the cord ends pointing toward the combustion chamber. The disadvantage is that the air suctioned into the air filter or the intake manifold of the vehicle has an extremely high velocity. The cord ends inside the air duct of the air filter or the oxygen intake pipe of the vehicle tends to be blown by the air, causing it to touch the air duct of the air filter or oxygen intake pipe, thereby causing sparks. In this invention, an insulation pipe is installed for inserting the electric or conductive metal cords into the air duct before entering the combustion chamber. The insulation pipe is attached to the air duct and the cord withstands suction pressure to better prevent sparks.

### Disadvantage 3

In the previous invention, the ends of the electric charge release cords featuring three electric wires with the ends diagonally cut are installed at the vehicle's air filter or oxygen intake pipe. The diagonally-cut ends of the cord are inserted into the oxygen intake pipe on three sides with the ends slightly exposed and the cord is adjusted so it tilts toward the combustion chamber. The disadvantage is that the end of the charge release cord is installed inside the oxygen intake pipe on three sides with the ends slightly exposed and the cord ends are adjusted so they tilts toward the combustion chamber, thereby making installation difficult because the end of the charge release cord needs to be installed on all three sides. The reason for the slight exposures of the cord ends is to prevent the air inside the oxygen intake pipe from blowing the cord ends, thereby causing them to touch the wall of the oxygen intake pipe to cause sparks. The inability to release high voltages of 1,000-60,000 volts results in inefficient release of electrical voltage into the air that enters the oxygen intake pipe rapidly and in large amounts. The diameter of the oxygen intake pipe is also larger.

In this invention, an insulation pipe for the electric or conductive metal cord is threaded through the air duct before the air enters the combustion chamber. The insulation pipe is attached to the air duct, resulting in at least one electric or conductive metal cord is in the center of the air duct to release voltage efficiently. The air inside the oxygen intake pipe enters rapidly and in large amounts with the larger diameter of the oxygen intake pipe. In addition, the electric or conductive metal cord is arranged so the end is in the shape of flat, vertically situated, fan-shape or half circle for high voltages of 1,000-60,000 volts to be released by numerous small wires contained within the large electric wire to offer sufficient surface area for the release of the high voltage. On the inner wall of the air duct on the opposite side of the location of electric or conductive metal cord a flat ring-shaped steel sheet divided into sections with a length shorter than that of the air duct is installed in order to attract high voltages of 1,000-60,000 volts for transmitting through the air duct.

### SUMMARY OF THE INVENTION

The image shows that the Engine Combustion System Oxygen Efficiency Enhancing Device with Raised Electrical Voltage and Improved Installation Method is composed of the following:

The air duct is characterized by a cylindrical duct with large diameter serves as an airway before the air enters the engine's combustion chamber. One location of the air duct contains a drilled hole for the installation of the insulation pipe. The electric or conductive metal cord is threaded through the insulation pipe with the end of the cord in the center of the air duct to release high voltage at 1,000-60,000 volts for convenient movement within the air duct. One side of the air duct is connected to the butterfly wing set, which is connected to the vehicle's body by the ground wire.

The electric or conductive metal is shaped like and electric cord with a large diameter and containing numerous small electrical wires to provide sufficient surface area for the transmission of high electrical voltage at 1,000-60,000 volts. The electric or conductive metal cord is made of a large minimum number of electrical wires. The electric wires are formed into flat, fan-shaped or half-circle-shaped ends that remain in the center of the air duct to release high voltages of 1,000-60,000 volts within the air duct conveniently.

The insulation pipe is characterized by a small diameter pipe for threading the electric or conductive metal cord and consists of upper and lower parts. The upper part is installed at the outside of the air duct and the lower part is installed at the inside of the air duct through the hole on the air duct that serves to allow the electric wire or conductive metal to be threaded through the insulation pipe in order for the end of the electric or conductive metal cord remaining in the center of the air duct to release high voltages of 1,000-60,000 volts within the air duct conveniently and withstand the suction pressure within the air duct to prevent the cord from touching the wall of the air duct and causing sparks.

At one location of the upper part, there is a board with a diameter that is larger than the insulation pipe to prevent the insulation pipe from moving through the drilled hole and to be installed it at this location. At a location on the board, a valve protrudes perpendicular to the board on the same plane. At the end of the valve, there is a partition protruding perpendicular to the valve. The lower surface of the valve touches the outer surface of the air duct to serve as the place for the strap to be fastened and the wall serves to prevent the strap from moving away from the valve. The strap is tightly fastened to the insulation pipe at this location with the upper and lower parts perpendicular to the air duct.

The attracting plate is characterized as a flat steel sheet shaped like a ring divided into sections and its length is shorter than the air duct. The attracting plate is installed at the inner wall of the air duct on the opposite side of the location of the electric or conductive metal cord and the insulation pipe, serving to attract high voltages of 1,000-60,000 volts so it travels through the air duct. The attracting plate is fastened to the inner wall of the air duct with screws.

The frequency generator, one side of which is connected to the vehicle's direct current power supply, serves to generate half-wave frequencies by releasing either positive or negative charges.

The transformer connected to the frequency generator serves to receive electrical voltage from the frequency generator and convert the voltage from 12-30 volts to high voltages of 1,000-60,000 volts by releasing either positive or negative charges with the current set at 0.0001 amperes to ensure the oxygen available in the air has more positive or negative molecules and to purify the oxygen, thereby causing its heavier molecular mass to be separated under the theory that the efficiency of an engine's internal combustion depends on the amount and purity of oxygen.

The operation system begins from the vehicle's direct current power supply to the frequency generator to the transformer to the electric or conductive metal cord to the insulation pipe and to the air duct, respectively.

The goal of this invention is to obtain an engine combustion system oxygen efficiency enhancing device with raised electrical voltage and an improved installation method that is capable of converting voltage from normal voltages of 12-30 volts to high voltages of 1,000-60,000 volts so the oxygen available in the air has more positive or negative molecules and to purify the oxygen, causing its heavier molecular mass to be separated.

An additional objective is to obtain an engine combustion system oxygen efficiency enhancing device with raised electrical voltage and improved installation method for easy installation and prevention of sparks from the electric wire or conductive metal from touching the wall of the air duct due to the air pressure inside the air duct.

### BRIEF DESCRIPTION OF DRAWINGS

FIG. 1 shows parts of the engine combustion system oxygen efficiency enhancing device with raised electrical voltage and improved installation method in this invention.

FIG. 2 shows parts of the engine combustion system oxygen efficiency enhancing device with raised electrical voltage and improved installation method in this invention.

FIG. 3 shows parts of the engine combustion system oxygen efficiency enhancing device with raised electrical voltage and improved installation method in this invention.

FIG. 4 shows parts of the engine combustion system oxygen efficiency enhancing device with raised electrical voltage and improved installation method in this invention.

FIG. 5 shows parts of the engine combustion system oxygen efficiency enhancing device with raised electrical voltage and improved installation method in this invention.

FIG. 6 shows parts of the engine combustion system oxygen efficiency enhancing device with raised electrical voltage and improved installation method in this invention.

FIG. 7 shows a diagram of the functionality of the engine combustion system oxygen efficiency enhancing device with raised electrical voltage and improved installation method in this invention.

### DETAILED DESCRIPTION OF THE INVENTION

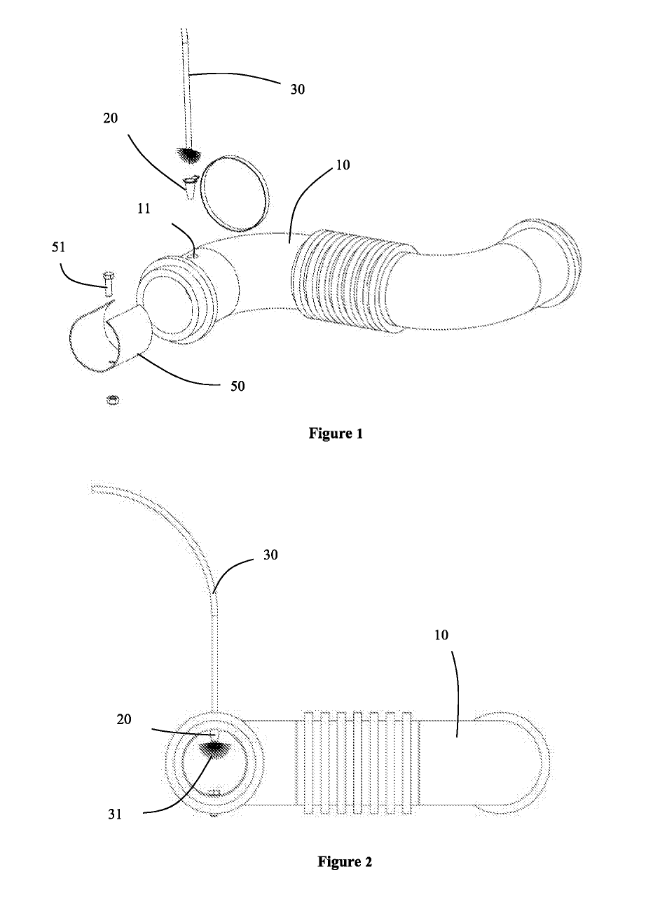

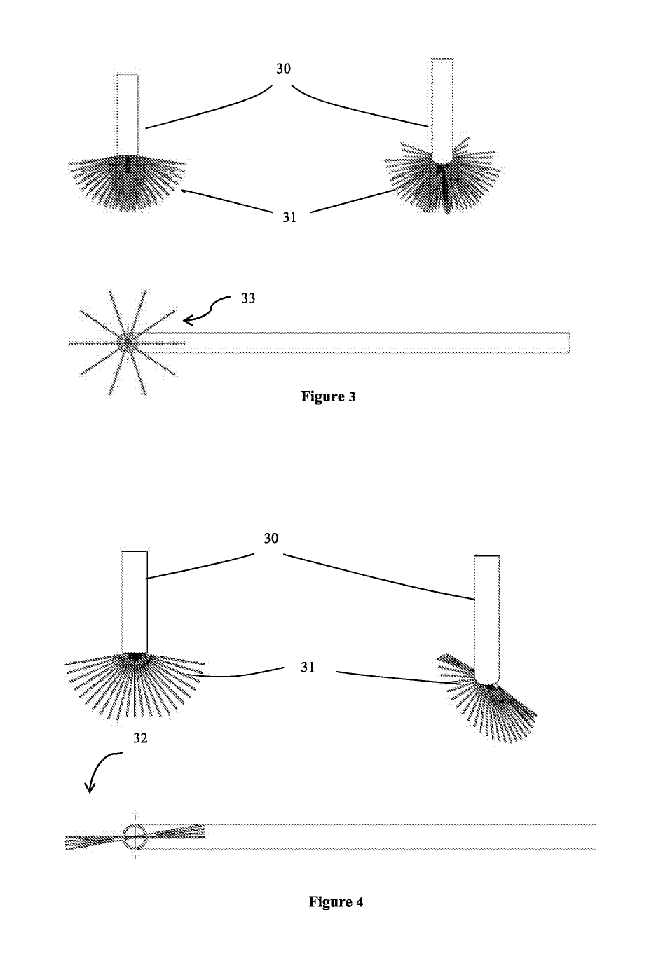

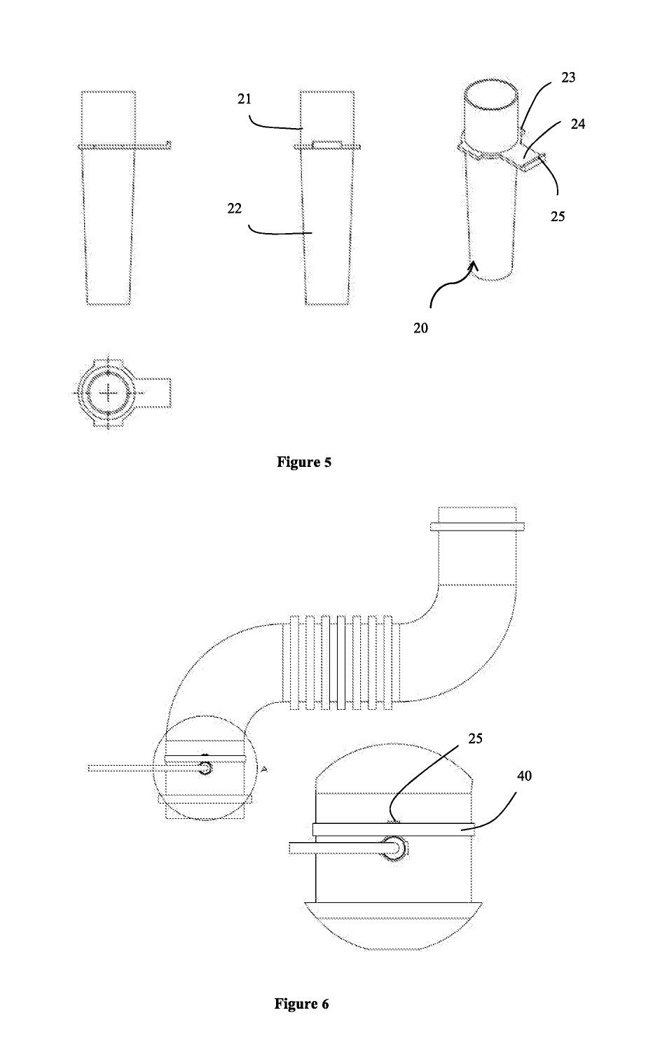

FIGS. 1 to 6 show the parts of the engine combustion system oxygen efficiency enhancing device with raised electrical voltage and improved installation method as follows:

The air duct (10) is characterized by a cylindrical duct with a large diameter serving as an airway before the air enters the combustion chamber (not shown). One location of the air duct (10) is a drilled hole (11) for supporting the installation of the insulation pipe (20). The electric or conductive metal cord (30) is threaded through the insulation pipe (20) with the end of the cord (30) at the center of the air duct (10) to release high voltages of 1,000-60,000 volts within the air duct (10) conveniently. One side of the air duct (10) is connected to the butterfly wing set (not shown), which is connected to the vehicle's body (not shown) by the ground wire (not shown).

The electric or conductive metal (30) in the form of electric wire with a large diameter containing numerous small electrical wires (31) allows for sufficient surface area for the high electrical voltages of 1,000-60,000 volts. The electric or conductive metal cord is made of a minimum of numerous electrical wires. The ends of the electric cord are formed into a flat, vertically situated, fan-shape (32) or half-circle (33) and remain at the center of the air duct (10) in order for high voltages of 1,000-60,000 volts released within the air duct (10) conveniently.

The insulation pipe (20) is characterized by a small diameter pipe for threading the electric or conductive metal cord (30). It consists of upper (21) and lower (22) parts. The upper part (21) is installed at the outside of the air duct and the lower part (22) is installed at the inside of the air duct (10) through the hole (11) on the air duct (10) that serves to allow the electric or the conductive metal for threading through the insulation pipe (20) with the end of the cord (30) in the center of the air duct (10) to release high voltage of 1,000-60,000 volts within the air duct (10) conveniently with ability to withstand the suctioning pressure within the duct in order to prevent the cord (30) from touching the wall of the air duct (10) to spark.

At one location of the upper part (21), there is a board (23) with a diameter that is larger than the insulation pipe (20) to prevent the insulation pipe (20) from moving through the drilled-hole (11) and be installed at this location. At a certain spot on the board (23), a valve (24) protrudes perpendicular to the board (23) on the same plane. At the end of the valve (24), there is a partition (25) protruding perpendicular to the valve (24). The lower surface of the valve (24) touches the outer surface of the air duct (10), serving as the place for the strap (40) to strap to the valve (24) and wall (25) preventing the strap (40) from moving away from the valve (24). The strap (40) tightly fastens the insulation pipe (20) to this location with the upper (21) and lower (22) parts of the insulation (20) perpendicular to the air duct (10).

The attracting plate (50) is characterized as a flat steel sheet that is ring-shaped and divided into sections and shorter than the air duct (10). The attracting plate (50) is installed at the inner wall of the air duct (10) on the opposite side of the location of the electric or conductive metal cord (30) and the insulation pipe (20) serves to attract high voltages of 1,000-60,000 volts released so it travels through the air duct (10). The attracting plate is fastened to the inner wall of the air duct (10) with screws (51).

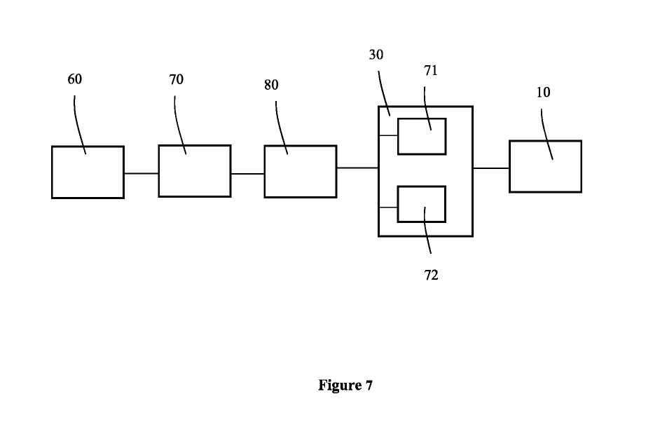

FIG. 7 shows a diagram of the functionality of the engine combustion system oxygen efficiency enhancing device with raised electrical voltage and improved installation method as follows:

The frequency generator (70) with one side connected to the vehicle's direct current power supply (60) serves to generate half-wave frequency by releasing either negative (71) or positive (72) charges.

The transformer (80) connected to the frequency generator (70) serves to receive electrical voltage from the frequency generator (70) and converts the voltage from 12-30 volts to high voltage in the form of the release of either negative (71) or positive (72) charges as received from the frequency generator (70) where:

At Level 1, the voltage is 1,000-8,000 volts and the electrical current is 0.0024-0.0003 amperes, or

At Level 2, electrical voltage is 8,001-15,000 volts and electrical current is 0.0003-0.00016 amperes, or

At Level 3, electrical voltage is 15,001-20,000 volts and electrical current is 0.00016-0.00012 amperes, or

At Level 4, electrical voltage is 20,001-30,000 volts and electrical current is 0.00012-0.00008 amperes, or

At Level 5, electrical voltage is 30,001-60,000 volts and electrical current is 0.00008-0.00004 amperes.

The release of either negative charges (71) or positive charges (72) with high voltage through the electric or conductive metal cord (30) to the air duct (10) gives the oxygen available in the air more positive or negative molecules and purifies the oxygen causing its heavier molecular mass to be separated under the theory that the efficiency of an engine's internal combustion depends on the amount and purity of oxygen before the air enters the combustion chamber.

The operation system begins with the vehicle's direct current power supply (60) to the frequency generator (70) to the transformer (80) to the electric or conductive metal cord (30) and to the air duct (10), respectively.

What is claimed is:

1. an engine combustion system oxygen efficiency enhancing device with raised electrical voltage and improved installation comprising:
an air duct comprising a cylindrical duct with a large diameter serving as an airway before the air enters the engine's combustion chamber;
at least one location of the air duct is connected to a butterfly wing set which is connected to a vehicle's body by a ground wire;
an electric or conductive wire with a large diameter comprising small electrical wires wherein the electric or conductive wire is connected to the air duct;
a frequency generator, one side of which is connected to the vehicle's direct current power supply;
a transformer connected to the frequency generator to receive electrical voltage from the frequency generator and convert the voltage from 12-30 volts to high voltage through electric or conductive metal cord to the air duct.

2. The engine combustion system oxygen efficiency enhancing device with raised electrical voltage and improved installation of claim 1 wherein the frequency generator is configured to generate half-wave frequency by releasing negative or positive charges.

3. The engine combustion system oxygen efficiency enhancing device with raised electrical voltage and improved installation method of claim 2 wherein one location of the air duct is a drilled hole for supporting the installation of the insulation pipe and the electric or conductive metal cord is threaded through the insulation pipe with the end of the cords remaining in the center of the air duct.

4. The engine combustion system oxygen efficiency enhancing device with raised electrical voltage and improved installation method of claim 3 wherein the electric or conductive metal cord with numerous small electrical wires located at the end of the air duct shaped into a flat, vertically situated, fan shape or half-circle remaining in the center of the air duct in order.

5. The engine combustion system oxygen efficiency enhancing device with raised electrical voltage and improved installation method of claim 4 wherein the insulation pipe comprises a small diameter pipe for threading the electric or conductive metal cord consists of upper and lower parts, wherein the upper part is installed at the outside of the air duct and the lower part is installed at the inside of the air duct through the hole on the air duct that serves to allow the electric or the conductive metal to be threaded through the insulation pipe in order for the end of the electric or conductive metal cord to be in the center of the air duct.

6. The engine combustion system oxygen efficiency enhancing device with raised electrical voltage and improved installation method of claim 5 wherein at one location of the upper part, there is a board with diameter larger than the insulation pipe to prevent the insulation pipe from moving through the drilled hole.

7. The engine combustion system oxygen efficiency enhancing device with raised electrical voltage and improved installation method of claim 6 wherein at one location on the board, a valve protrudes perpendicular to the board on the same plane and at the end of the valve, there is a partition protruding perpendicular to the valve, and wherein the lower surface of the valve serves as the place for the strap to strap to the valve and the wall preventing the strap from moving away from the valve.

8. The engine combustion system oxygen efficiency enhancing device with raised electrical voltage and improved installation method of claim 7 wherein the attracting plate is characterized as a flat steel sheet in a ring shape divided into sections and shorter than the air duct and the attracting plate is installed at the inner wall of the air duct on the opposite side of the location of the electric or conductive metal cord and the insulation pipe serves to attract the high voltage released.

9. The engine combustion system oxygen efficiency enhancing device with raised electrical voltage and improved installation method of claim 8 wherein the attracting plate is attached to the inner wall of the air duct with screws.

10. The engine combustion system oxygen efficiency enhancing device with raised electrical voltage and improved installation method of claim 9 wherein the operation system begins from the vehicle direct current power supply to the frequency generator to the transformer to the electric or conductive metal cord and to the air duct, respectively.
